(19) United States
(12) Patent Application Publication
(10) Pub. No.: US 2026/0070543 A1
(43) Pub. Date: Mar. 12, 2026

(54) VEHICLE OBSTACLE DETECTION MANAGEMENT

(71) Applicant: INTERNATIONAL BUSINESS MACHINES CORPORATION, ARMONK, NY (US)

(72) Inventors: Hao Xiang Wu, Beijing (CN); Zhe Yan, Beijing (CN); Li Li Guan, Beijing (CN); Rong Zhao, Beijing (CN); Li Bo Zhang, Beijing (CN)

(21) Appl. No.: 18/826,483

(22) Filed: Sep. 6, 2024

(51) Int. Cl. B60W 30/09; B60W 30/095; B60W 50/14; B60W 60/00

(52) U.S. Cl. CPC B60W 30/09; B60W 30/0953; B60W 30/0956; B60W 50/14; B60W 60/0015; B60W 2050/146; B60W 2554/4026; B60W 2554/4029; B60W 2554/4044

(57) ABSTRACT

Aspects of the present disclosure relate to vehicle obstacle detection management. A position of a first device can be obtained. A determination can be made that the first device is within a blind spot of a first vehicle, wherein the blind spot indicates that the first device is hidden by an obstacle within a field of view (FoV) of the first vehicle. A determination can be made that the first device has a projected movement path toward the first vehicle. In response to determining that the first device is within the blind spot of the first vehicle and that the first device has the projected movement path toward the first vehicle, a blind spot action can be issued to attempt to prevent a collision between the first device and the first vehicle.

### BACKGROUND

The present disclosure relates generally to the field of computing, and in particular, to vehicle obstacle detection management.

Semi-autonomous and autonomous vehicles (i.e., self-driving cars) are vehicles that include autonomation components sufficient for sensing their own environment and taking actions with limited human input. A variety of sensors can be incorporated into semi-autonomous or autonomous vehicles to receive environmental information in a vicinity of the vehicle. Advanced control systems can analyze the sensor data received from the integrated sensors to control functions of the vehicle, such as the navigation route or following distance.

A vehicular heads-up display (HUD) is a transparent display that presents data within a vehicle. This can allow users to view information while driving without looking away from their usual viewpoints. Various types of vehicular HUDs exist, including reflective HUDs (e.g., where a windshield is treated such that an image can be projected onto the windshield and reflected to the user), combiner HUDs, and wind-shield integrated HUDs (e.g., where a transparent display is disposed between layers of a windshield).

### SUMMARY

Aspects of the present disclosure relate to a computer program product, system, and method for vehicle obstacle detection management.

Aspects of the present disclosure are directed to a method. According to the method, a position of a first device can be obtained. A determination can be made that the first device is within a blind spot of a first vehicle, wherein the blind spot indicates that the first device is hidden by an obstacle within a field of view (FoV) of the first vehicle. A determination can be made that the first device has a projected movement path toward the first vehicle. In response to determining that the first device is within the blind spot of the first vehicle and that the first device has the projected movement path toward the first vehicle, a blind spot action can be issued to attempt to prevent a collision between the first device and the first vehicle.

Aspects are also directed to a computer program product comprising one or more computer readable storage media, and program instructions collectively stored on the one or more computer readable storage media, the program instructions comprising instructions configured to cause one or more processors to perform the above method.

Aspects of the present disclosure are also directed to a system comprising one or more processors and one or more computer-readable storage media collectively storing program instructions which, when executed by the one or more processors, are configured to cause the one or more processors to perform a method. The method comprises obtaining a first indication that a first device is within a blind spot of a first vehicle, wherein the blind spot indicates that the first device is hidden by an obstacle within a field of view (FoV) of the first vehicle. The method further comprises obtaining a second indication that the first device has a projected movement path toward the first vehicle. The method further comprises issuing, by the first vehicle responsive to the first and second indications, a blind spot action to attempt to prevent collision between the first device and the first vehicle.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example network environment, in accordance with embodiments of the present disclosure.

FIG. 3 is a diagram depicting an environment implementing vehicular obstacle detection management, in accordance with embodiments of the present disclosure.

FIG. 4 is a block diagram illustrating an example network environment including a vehicle obstacle detection management system, in accordance with embodiments of the present disclosure.

FIG. 5 is a flow-diagram illustrating an example method for vehicle obstacle detection management, in accordance with embodiments of the present disclosure.

FIG. 6 is a flow-diagram illustrating another example method for vehicle obstacle detection management, in accordance with embodiments of the present disclosure.

FIG. 7 is a flow-diagram illustrating another example method for vehicle obstacle detection management, in accordance with embodiments of the present disclosure.

FIG. 8 is a flow-diagram illustrating an example method for vehicle obstacle detection, in accordance with embodiments of the present disclosure.

FIG. 9 is a diagram illustrating exemplary visual data that can displayed within a vehicle as a blind spot action, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and more particularly, to vehicle obstacle detection management. While the present disclosure is not necessarily limited to such applications, various aspects of the disclosure may be appreciated through a discussion of various examples using this context.

Within vehicular environments, drivers can encounter visual obstructions such as buildings, other vehicles, landscapes, and signage. Such visual obstructions can create blind spots that hide pedestrians, cyclists, vehicles, or other moving objects. When a pedestrian, cyclist, vehicle, etc. exits a blind spot in a direction moving toward a traveling vehicle with an obstructed view, a sudden accident can occur, causing vehicular damage, injury, or loss of life. This can occur without adequate notice/warning for the driver or vehicle (e.g., in situations including autonomous vehicles) to react.

The following description provides examples of embodiments of the present disclosure, and variations and substitutions may be made in other embodiments. Several examples will now be provided to further clarify various aspects of the present disclosure.

Example 1: A computer-implemented method that comprises obtaining a position of a first device. The method further comprises determining that the first device is within a blind spot of a first vehicle, wherein the blind spot indicates that the first device is hidden by an obstacle within a field of view (FoV) of the first vehicle. The method further comprises determining that the first device has a projected movement path toward the first vehicle. The method further comprises issuing, in response to determining that the first device is within the blind spot of the first vehicle and that the first device has the projected movement path toward the first vehicle, a blind spot action to attempt to prevent a collision between the first device and the first vehicle.

The above limitations advantageously enable the accurate detection of devices hidden within blind spots of moving vehicles. By determining that the first device is within the blind spot of the first vehicle and further by determining that the first device has a projected movement path towards the first vehicle, proactive determination that a collision may occur can be completed. This can enable notifying the driver of the first vehicle and/or the user of the first device such that a collision can be avoided. In situations where the first vehicle is autonomous, the first vehicle can be automatically controlled to avoid collision. Thus, the above limitations advantageously improve safety within vehicular environments. Further, aspects of the present disclosure can utilize existing sensors and/or processors within vehicular environments to perform functionalities of vehicular obstacle detection management, thereby improving computing efficiency.

Example 2: The limitations of Example 1, where determining that the first device is within the blind spot of the first vehicle includes obtaining a position of the obstacle, obtaining physical characteristics of the obstacle, and determining that the first device is hidden by the obstacle within the FoV of the first vehicle based on the position of the first device with respect to the position of the obstacle and the physical characteristics of the obstacle. The above limitations advantageously enable accurate detection of devices within blind spots. For example, by determining the position of the first device with respect to the position of the obstacle, it can accurately be determined that the first device is visually obstructed by the obstacle with respect to the first vehicle's FoV. Further, physical characteristics such as physical dimensions and/or light characteristics of the obstacle can indicate the size and/or transparency of the obstacle, thereby improving accuracy of blind spot detection (e.g., whether a user of the first device is visible to the driver of the first vehicle based on the size and/or transparency of the obstacle).

Example 3: The limitations of any of Examples 1 or 2, where issuing the blind spot action comprises causing display of the projected movement path of the first device on a display device within the first vehicle. The above limitations advantageously enable a driver of the first vehicle to be visually warned of the first device hidden within the blind spot. Thus, the driver may have adequate time to take action to prevent collision with a user of the first device. Further, display of the projected movement path may aid the driver of the first vehicle to determine an appropriate vehicular action (e.g., steering versus braking) to take to prevent collision.

Example 4: The limitations of any of Example 3, where the display device within the first vehicle is a head-up display (HUD). The above limitations advantageously enable the driver of the first vehicle to be visually warned of the first device within their blind spot without requiring the driver of the first vehicle to look away from their usual viewpoints, thereby enhancing safety within vehicular environments.

Example 5: The limitations of any of Examples 1 - 4, where the first vehicle includes autonomous capabilities, wherein issuing the blind spot action comprises causing the first vehicle to perform an autonomous vehicle action to prevent the first vehicle from colliding with the first device. The above limitations advantageously enable a vehicle with autonomous capabilities to automatically avoid collisions with a user of the first device, thereby enhancing safety within vehicular environments.

Example 6: The limitations of any of Examples 1- 5, where issuing the blind spot action comprises issuing a warning to the first device notifying the first device of the first vehicle. The above limitations advantageously enable warning a user of the first device of the oncoming vehicle. This can prevent collision, thereby improving safety within vehicular environments.

Example 7: The limitations of any of Examples 1- 6, wherein determining that the first device has a projected movement path toward the first vehicle is determined based on historical positioning data associated with the first device. The above limitations advantageously enable accurate detection of projected movement paths based on historical positioning data of devices. This can enable accurate identification of situations where blind spot actions should be issued to prevent potential collision.

Example 8: A system comprising one or more processors and one or more computer-readable storage media collectively storing program instructions which, when executed by the one or more processors, are configured to cause the one or more processors to perform a method comprising obtaining a first indication that a first device is within a blind spot of a first vehicle, wherein the blind spot indicates that the first device is hidden by an obstacle within a field of view (FoV) of the first vehicle. The method further comprises obtaining a second indication that the first device has a projected movement path toward the first vehicle. The method further comprises issuing, by the first vehicle responsive to the first and second indications, a blind spot action to attempt to prevent collision between the first device and the first vehicle. The limitations of Example 8 realize the advantages discussed with respect to Example 1.

Example 9: The limitations of Example 8, where issuing, by the first vehicle, the blind spot action comprises displaying the projected movement path of the first device on a display device within the first vehicle. The limitations of Example 9 realize the benefits of Example 3.

Example 10: The limitations of Example 9, where an object associated with the first device is displayed with the projected movement path within the blind spot action. The above limitations advantageously enable a driver of the first vehicle to view the appearance of an object associated with the first device (e.g., whether the first device is associated with a bicycle, pedestrian, vehicle, etc.). This can enable the driver of the first vehicle to take appropriate action to avoid collision with the object associated with the first device.

Example 11: The limitations of any of Examples 9-10, where the display device within the first vehicle is a head-up display (HUD). The limitations of Example 11 realize the advantages discussed with respect to Example 4.

Example 12: The limitations of any of Examples 8-11, where the first vehicle includes autonomous capabilities, where issuing, by the first vehicle, the blind spot action comprises performing an autonomous vehicle action to prevent the first vehicle from colliding with the first device. The limitations of Example 12 realize the advantages discussed with respect to Example 5.

Example 13: The limitations of any of Examples 8-12, where issuing, by the first vehicle, the blind spot action comprises issuing a warning to the first device notifying the first device of the first vehicle. The limitations of Example 13 realize the advantages discussed with respect to Example 6.

Example 14: The limitations of any of Examples 8-13, wherein the first and second indications are obtained from an edge computing device within a vehicular environment of the first vehicle. The above limitations advantageously enable nearby processing devices (e.g., edge computing devices) proximate to a source where computing is required (e.g., a vehicular environment) to determine the existence of the blind spot and the projected movement path. This directly improved processing efficiency, removing the need for the first vehicle, first device, and/or a remote processing system (e.g., a server) to perform certain processing functionalities required for vehicle obstacle detection management.

Example 15: A computer program product comprising one or more computer readable storage media, and program instructions collectively stored on the one or more computer readable storage media, the program instructions comprising instructions configured to cause one or more processors to perform the method according to any of Examples 1-14. The computer program product of Example 15 realizes the benefits described with respect to Examples 1-14. The computer program product of Example 15 can advantageously be implemented into a variety of computer program products.

Aspects of the present disclosure can be implemented in a variety of technical use cases. The following use cases are merely exemplary and are not intended to limit the scope of the disclosure. For example, aspects of the present disclosure can be implemented within vehicular environments in manual, semi-autonomous, or fully autonomous vehicles. In manual or semi-autonomous vehicles, visual and/or audio warnings of devices within blind spots of moving vehicles can be issued such that drivers of such vehicles can take appropriate action to avoid collision. In semi-autonomous or fully autonomous vehicles, such vehicles can be automatically controlled to prevent collision based on detection of devices within blind spots (e.g., and projected movement paths thereof). Aspects of the present disclosure can also be implemented within marine or aerial environments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

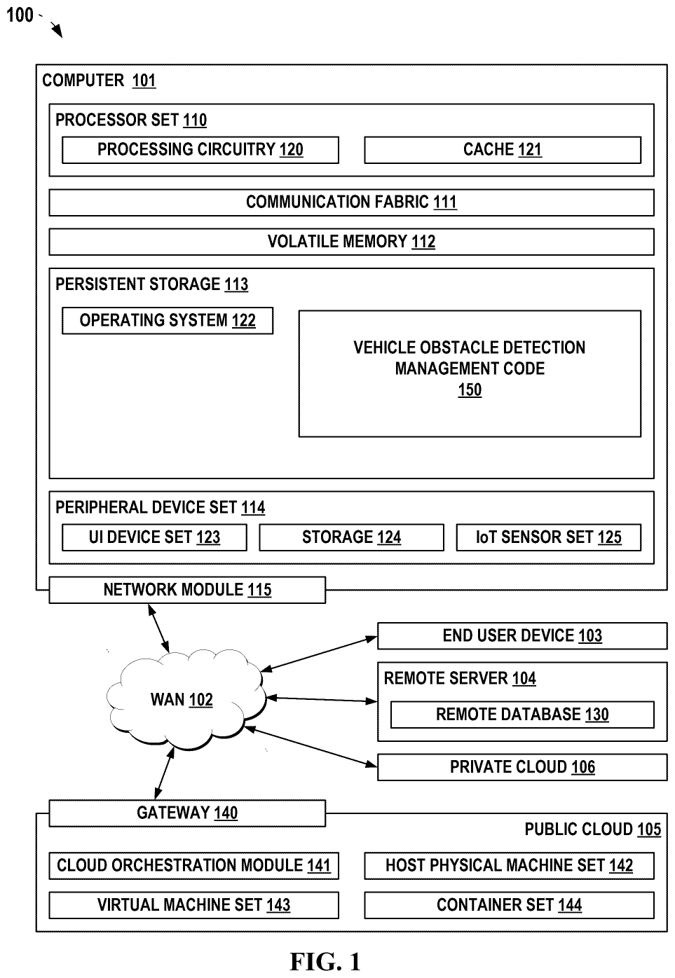

FIG. 1 is a high-level block diagram illustrating an example computing environment 100 that can be used in implementing one or more of the methods, tools, modules, and any related functions described herein, in accordance with embodiments of the present disclosure.

Computing environment 100 contains an example of an environment for the execution of at least some of the computer code involved in performing the inventive methods, such as vehicle obstacle detection management code 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vehicle obstacle detection management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in v vehicle obstacle detection management code 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in vehicle obstacle detection management code 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

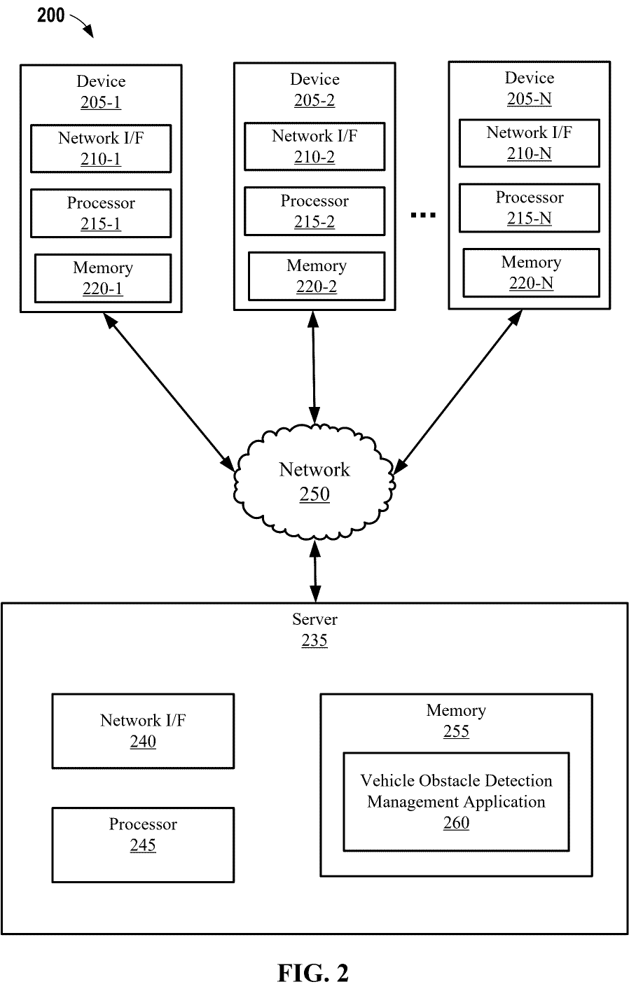

FIG. 2 is a block diagram illustrating an example computing environment 200 in which illustrative embodiments of the present disclosure can be implemented. Computing environment 200 includes a plurality of devices 205-1, 205-2, . . . , 205-N (collectively devices 205), at least one server 235, and a network 250.

The devices 205 and the server 235 include one or more processors 215-1, 215-2, . . . , 215-N (collectively processors 215) and 245 and one or more memories 220-1, 220-2, . . . , 220-N (collectively memories 220) and 255, respectively. The processors 215 and 245 can be the same as, or substantially similar to, processor set 110 of FIG. 1. The memories 220 and 255 can be the same as, or substantially similar to volatile memory 112 and/or persistent storage 113 of FIG. 1.

The devices 205 and the server 235 can be configured to communicate with each other through internal or external network interfaces 210-1, 210-2, . . . , 210-N (collectively network interfaces 210) and 240. The network interfaces 210 and 240 are, in some embodiments, modems or network interface cards. The network interfaces 210 and 240 can be the same as, or substantially similar to, network module 115 described with respect to FIG. 1.

The devices 205 and/or the server 235 can be equipped with a display or monitor. Additionally, the devices 205 and/or the server 235 can include optional input devices (e.g., a keyboard, mouse, scanner, a biometric scanner, video camera, or other input device), and/or any commercially available or custom software (e.g., web conference software, browser software, communications software, server software, natural language processing software, search engine and/or web crawling software, image processing software, augmented reality/virtual reality (AR/VR) software, autonomous driving software, positioning system software, etc.). For example, devices 205 and/or server 235 can be, or include, components/devices such as those described with respect to peripheral device set 114 of FIG. 1. The devices 205 and/or the server 235 can be servers, desktops, laptops, vehicles, edge computing nodes, or hand-held devices. The devices 205 and/or the server 235 can be the same as, or substantially similar to, computer 101, remote server 104, and/or end user device 103 described with respect to FIG. 1.

The devices 205 and the server 235 can be distant from each other and communicate over a network 250. In some embodiments, the server 235 can be a central hub from which devices 205 can establish a communication connection, such as in a client-server networking model. Alternatively, the server 235 and devices 205 can be configured in any other suitable networking relationship (e.g., in a peer-to-peer (P2P) configuration or using any other network topology).

In some embodiments, the network 250 can be implemented using any number of any suitable communications media. In embodiments, the network 250 can be the same as, or substantially similar to, WAN 102 described with respect to FIG. 1. For example, the network 250 can be a wide area network (WAN), a local area network (LAN), an internet, or an intranet. In certain embodiments, the devices 205 and the server 235 can be local to each other and communicate via any appropriate local communication medium. For example, the devices 205 and the server 235 can communicate using a local area network (LAN), one or more hardwire connections, a wireless link or router, or an intranet. In some embodiments, the devices 205 and the server 235 can be communicatively coupled using a combination of one or more networks and/or one or more local connections. For example, the first device 205-1 can be hardwired to the server 235 (e.g., connected with an Ethernet cable) while the second device 205-2 can communicate with the server 235 using the network 250 (e.g., over the Internet).

In some embodiments, the network 250 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 250. In embodiments, network 250 can be coupled with public cloud 105 and/or private cloud 106 described with respect to FIG. 1.

The server 235 includes a vehicle obstacle detection management application (VODMA) 260. The VODMA 260 can be configured to analyze data within a vehicular environment to determine whether devices (e.g., and corresponding users) are within blind spots of particular vehicles. A device being within a blind spot of a particular vehicle (e.g., a hidden device) refers to the device being hidden behind an obstacle within a field of view (FoV) of the particular vehicle. The VODMA 260 can further be configured to determine whether devices within blind spots of vehicles have projected movement paths toward moving vehicles. The VODMA 260 can be configured to issue one or more blind spot actions when a device is within a blind spot of a particular vehicle and has a projected movement path toward the particular vehicle. Blind spot actions include causing display of visual data within vehicles indicating positions and projected movement paths of hidden devices approaching moving vehicles, issuing warnings to hidden devices warning hidden devices of oncoming moving vehicles, and/or causing autonomous or semi-autonomous vehicles to automatically perform control actions to prevent collisions with hidden devices, among others.

The VODMA 260 can be configured to receive positioning data from devices within a vehicular environment. Positioning data refers to data that indicates one or more positions of respective devices, vehicles, or other objects with positioning capabilities (e.g., devices 205), within space. Various types of positioning data can be received, including, for example, global positioning system (GPS) data or local positioning system (LPS) data. GPS data can indicate a 3D space position of a device based on, for example, satellite-based radio navigation. LPS data can indicate a 3D space position of a device based on a plurality of signaling beacons within a given space, for example, using trilateration. However, various types of positioning data obtained by various positioning techniques can be implemented to determine respective positions of devices within a vehicular environment without departing from the spirit and scope of the present disclosure. For example, in embodiments, devices implementing a short-range wireless technology protocol, such as BLUEBOOTH®, can be located via an angle of arrival (AoA) antenna array (e.g., a Bluetooth AoA antenna array). In this example, each device can be located using calculations based on signals transmitted from and/or received by the AoA antenna array.

The VODMA 260 can also be configured to determine mobility characteristics of devices within the vehicular environment. Mobility characteristics refer to the speed and direction (e.g., velocity) of devices within the vehicular environment. Mobility characteristics can also refer to acceleration and deceleration of devices within vehicular environments. The mobility characteristics of respective devices within the vehicular environment can be determined based on historically received positioning data. For example, the positioning data can indicate the amount of time a particular device takes to travel from a first position to a second position, and thus the speed/velocity of the device. Further, based on changes of speed/velocity over time, acceleration and/or deceleration of devices can be determined. In embodiments, mobility characteristics of a given device can be based on a specific timeframe, such as an average speed/velocity/acceleration over a given time interval (e.g., average speed over the last minute, hour, day, week, etc.). Mobility characteristics can be used to determine projected movement paths of specific devices.

In embodiments, mobility characteristics of a given device can be used to classify the device into a mobility classification. The mobility classification of the device can be completed based on statistical measures within the mobility characteristics. For example, if a given device has an average speed of 15 miles per hour (mph) over the last hour, a determination can be made that the device is “a user of a bicycle” (e.g., a first classification). As another example, if a given device has an average speed of 3 mph over the last 15 minutes, a determination can be made that the device is a “pedestrian” (e.g., a second classification). Any suitable type of mobility classification can be determined for specific devices based on mobility characteristics associated therewith. Mobility classifications can be used to determine projected movements paths of devices within the vehicular environment based on their current position. The mobility classifications can also be used to augment virtual avatars corresponding to hidden devices to be used in blind spot action warnings.

The VODMA 260 can be configured to receive obstacle data within the vehicular environment. The obstacle data can indicate the position, physical characteristics (e.g., light characteristics and physical dimensions), and velocity of obstacles within the vehicular environment. As referenced herein “an obstacle” refers to a particular object that is obstructing a field of view (e.g., a visual obstruction) of a vehicle within the vehicular environment. Thus, obstacles can include a variety of objects such as vehicles, buildings, landscaping features (e.g., boulders), signage, and structures (e.g., bus stops), to name a few. Obstacles can be moving or non-moving objects. Obstacles can be devices or can be associated with devices.

In embodiments where an obstacle is a device (e.g., a vehicle) or is otherwise associated with a device (e.g., pedestrians on a carriage or pedal tavern, bicyclists, etc.), positioning data and mobility characteristics of the device(s) associated with the obstacle can be used to determine portions of obstacle data associated therewith. For example, if the obstacle is a vehicle, positioning data and mobility characteristics of the vehicle can be used to determine obstacle data associated with the vehicle. In embodiments where the obstacle is not associated with a device, sensors within a sensor network, such as vehicular sensors, traffic device sensors, or other types of sensors can be configured to collect/determine obstacle data. For example, a computer vision sensor associated with a vehicle, such as a camera or light detection and ranging (LIDAR) sensor, can be used to determine obstacle data of a first obstacle (e.g., a position, speed, size, and/or light characteristics of the first obstacle).

In embodiments, a combination of positioning data, mobility characteristics, and/or sensor data can be used to determine obstacle data. For example, if the obstacle is a first vehicle, the position and mobility characteristics of the first vehicle can be determined using positioning data while the physical characteristics of the first vehicle can be determined using computer vision sensors of one or more vehicles within an internet of vehicles (IoV) network. However, it is noted that any suitable type of data source, number of data sources, and/or type of data can be used to determine features of obstacles (e.g., obstacle data) within a vehicular environment without departing from the spirit and scope of the present disclosure. VODMA 260 can analyze the obstacle data with respect to positioning data and mobility characteristics of devices to determine whether a device is hidden within a blind spot behind a first obstacle with respect to a FoV of a first vehicle. The VODMA 260 can further analyze whether the device has a projected movement path toward the first vehicle based on the position and mobility characteristics of the device. The VODMA 260 can use such conditions (e.g., whether a device is within a blind spot of a FoV of a vehicle and whether the device has a movement path toward the vehicle) for issuing blind spot actions. A “blind spot action” refers to a command that notifies, warns, or causes control actions (e.g., braking, steering, etc.) to attempt to prevent a collision between a device within a blind spot of a vehicle and the vehicle.

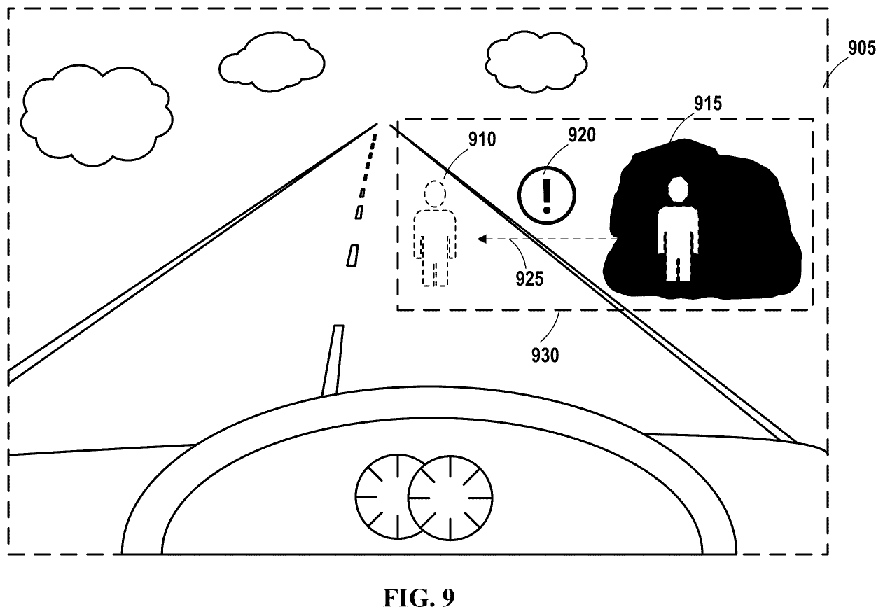

For example, VODMA 260 can be configured to cause display of visual data warning a driver of a first vehicle of a position and projected path of a pedestrian in possession of a device. If VODMA 260 determines that an obstacle is obstructing a FoV of a driver of the first vehicle based on the position of the pedestrian with respect to the characteristics of the obstacle (e.g., the obstacle is positioned in front of the pedestrian, the obstacle has physical dimensions that obstruct the pedestrian, and the obstacle has non-transparent light characteristics), then the VODMA 260 can be configured to cause display of visual data (e.g., on an HUD of the vehicle) warning the driver of the first vehicle of the position and projected movement path of the pedestrian. In some embodiments, the visual data warning the driver is only displayed if the projected path of the pedestrian is toward the first vehicle. FIG. 9 depicts exemplary visual data that can be displayed on a display device within a first vehicle warning a driver of the first vehicle of a pedestrian hidden behind an obstacle.

In embodiments where the moving vehicle to be warned of the hidden device is autonomous or semi-autonomous (e.g., requiring no visual warning or manual intervention), the VODMA 260 can be configured to issue a blind spot action to cause the first vehicle to perform one or more control actions to prevent collision with the hidden device. For example, the VODMA 260 can be configured to cause the first vehicle to brake, steer, or otherwise avoid the hidden device. In embodiments, the VODMA 260 can be configured to issue a blind spot action that causes one or more devices in the vicinity to perform an action warning the hidden device of the approaching vehicle, or vice versa. For example, the VODMA 260 can be configured to cause the driving vehicle approaching the blind spot to activate a horn. As another example, the VODMA 260 can be configured to issue a blind spot action that transmits a warning to the hidden device notifying the hidden device of the oncoming vehicle. However, a variety of blind spot actions can be issued, to be discussed further below.

Thus, the VODMA 260 can be configured to detect pedestrians (e.g., associated with devices), bicyclists (e.g., associated with devices), vehicles, or moving devices (e.g., robotic devices such as street sweepers, robotic vacuums, etc.) hidden within blind spots of FoVs of particular vehicles. The VODMA 260 can further be configured to determine projected movement paths of devices hidden within blind spots of FoVs of particular vehicles. The VODMA 260 can be configured to issue one or more blind spot actions to prevent collisions between hidden devices and moving vehicles based on detecting that a given device is within a blind spot of a given vehicle and/or based on determining that the projected movement path of the device is toward the vehicle.

It is noted that FIG. 2 is intended to depict the representative major components of an example computing environment 200. In some embodiments, however, individual components can have greater or lesser complexity than as represented in FIG. 2, components other than, or in addition to, those shown in FIG. 2 can be present, and the number, type, and configuration of such components can vary.

While FIG. 2 illustrates a computing environment 200 with a single server 235, suitable computing environments for implementing embodiments of this disclosure can include any number of servers. The various models, modules, systems, and components illustrated in FIG. 2 can exist, if at all, across a plurality of servers and devices. For example, some embodiments can include two servers. The two servers can be communicatively coupled using any suitable communications connection (e.g., using a WAN 102, a LAN, a wired connection, an intranet, or the Internet).

Though this disclosure pertains to the collection of personal data (e.g., positioning data, mobility characteristics, and obstacle data), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

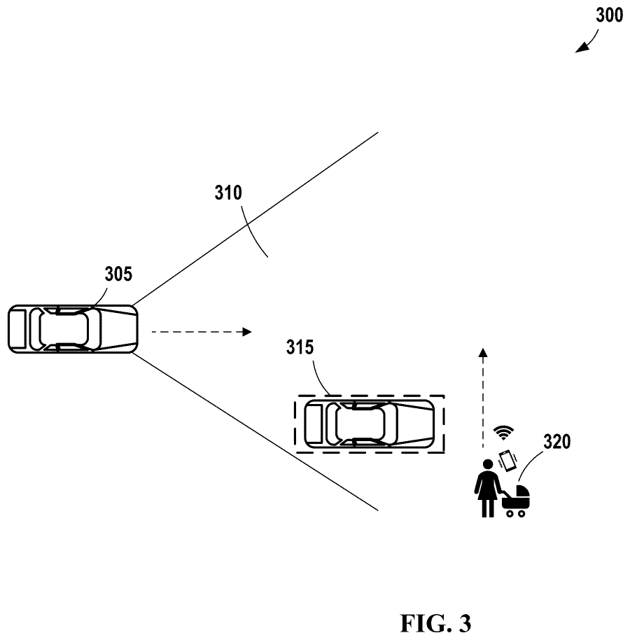

Referring now to FIG. 3, shown is a vehicular environment 300 depicting aspects of vehicle obstacle detection management, in accordance with embodiments of the present disclosure. As depicted in FIG. 3, within the vehicular environment 300 (e.g., a traffic environment such as a road, intersection, driveway, etc.) a first vehicle 305 is driving forward. A field of view (FoV) 310 of the first vehicle is depicted. The FoV 310 corresponds to an area that a driver of the first vehicle 305 or vehicular vision sensors of the first vehicle 305 (e.g., if the first vehicle 305 is an autonomous or semi-autonomous vehicle) can view or otherwise sense. As depicted in FIG. 3, a second vehicle 315 is positioned within the FoV 310 of the first vehicle 305. For example, the second vehicle 315 may be parked within the FoV 310 of the first vehicle 305. A pedestrian 320 is hidden within a blind spot of the first vehicle 305 behind the second vehicle 315 (e.g., an obstacle) with respect to the FoV 310 of the first vehicle 305. Further, the pedestrian 320 is traveling in a direction toward where the first vehicle 305 is moving (e.g., has a projected movement path toward the first vehicle 305). Thus, FIG. 3 depicts a dangerous scenario where the pedestrian 320 may be struck by the first vehicle 305 due to a user of the first vehicle 305, or alternatively, sensors of the first vehicle 305, not being able to detect the pedestrian with enough time to react to prevent collision.

Aspects of the present disclosure address this scenario by enabling blind spot actions to be issued that warn the first vehicle 305 and/or pedestrian 320 of the potential danger.

Additionally or alternatively, aspects of the present disclosure can directly cause the first vehicle 305 to avoid a collision. For example, as discussed above, the position and mobility characteristics of the pedestrian 320 can be determined using positioning data of the pedestrian's 320 device (e.g., shown as a device with a wireless signal in FIG. 3). Further, obstacle data associated with the second vehicle 315 can be obtained. As such, the position of the second vehicle 315, movement of the second vehicle 315, and physical characteristics of the second vehicle 315 can be obtained. The position and mobility characteristics of the pedestrian 320 can then be analyzed with respect to the obstacle data of the second vehicle 315 to determine whether the pedestrian 320 is within a blind spot of the first vehicle 305 (e.g., hidden behind the second vehicle 315 with respect to the FoV 310 of the first vehicle 305) and whether the pedestrian 320 has a projected movement path toward where the first vehicle 305 is moving (e.g., a projected path of the pedestrian 320 is moving toward a projected path of the oncoming first vehicle 305).

If it is determined that the pedestrian 320 is within the blind spot of the first vehicle 305 and/or has a projected movement path toward where the first vehicle 305 is moving, then one or more blind spot actions can be issued to warn the first vehicle 305 and/or pedestrian 320 of the potential collision. These blind spot actions can include displaying a visual warning on a display within the first vehicle 305 indicating a position and projected movement path of the pedestrian 320, causing an alarm to occur on the first vehicle 305 (e.g., a horn) or another nearby vehicle or device (e.g., a traffic directing device), or causing a warning notification at the device of the pedestrian 320 (e.g., a mobile device sound or vibration). In scenarios where the first vehicle 305 is autonomously or semi-autonomously controlled, the blind spot action can include issuing a command to cause the first vehicle 305 to avoid collision with the pedestrian 320, such as issuing a command to cause the first vehicle 305 to brake or steer.

FIG. 3 depicts an exemplary vehicular environment 300 where vehicle obstacle detection management can be implemented. The number of vehicles, types of vehicles, types of obstacles, and types of hidden objects (e.g., pedestrian 320) can vary without departing from the spirit and scope of the present disclosure. For example, in a marine vehicle obstacle detection environment, the first vehicle 305 can be a first boat, the second vehicle 315 can be a second boat, and the hidden object (e.g., pedestrian 320) can be a third boat or swimming individual. As another example, in an aerial vehicle obstacle detection environment, the first vehicle 305 can be a first aircraft, the second vehicle 315 can be a second aircraft or cloud, and the hidden object (e.g., pedestrian 320) can be a third aircraft.

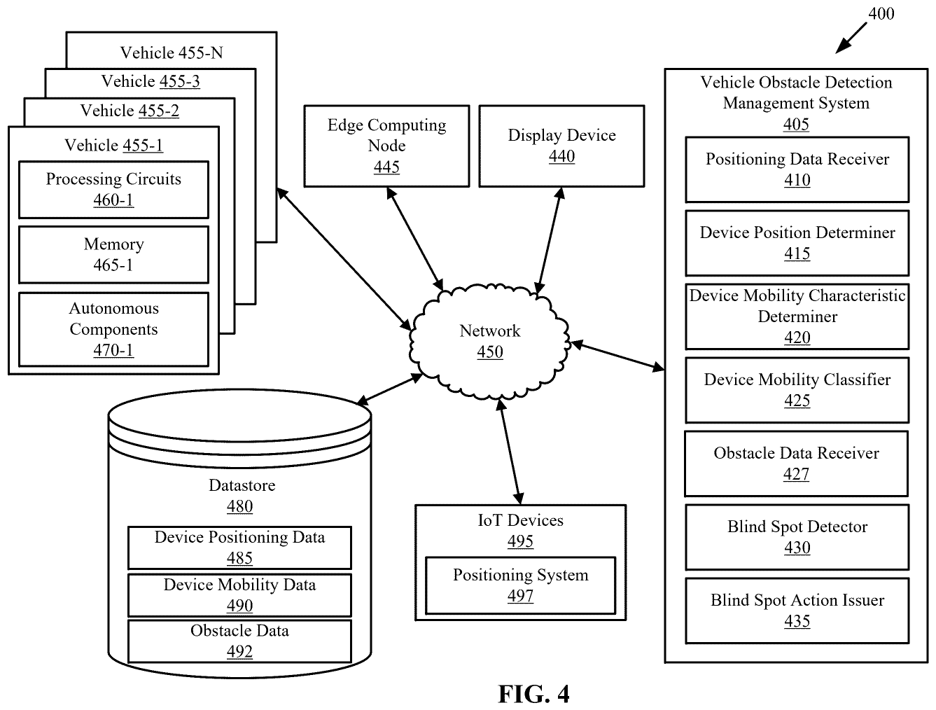

Referring now to FIG. 4, shown is a block diagram illustrating an example network environment 400 in which illustrative embodiments of the present disclosure can be implemented. The network environment 400 includes a vehicle obstacle detection management system (VODMS) 405, a display device 440, an edge computing node 445, vehicles 455-1, 455-2, 455-3 . . . 455-N (e.g., collectively vehicles 455), a datastore 480, and IoT devices 495, each of which can be communicatively coupled for intercomponent interaction via a network 450. In embodiments, the network 450 can be the same as, or substantially similar to, network 250 and/or WAN 102. In embodiments, the VODMS 405, display device 440, edge computing node 445, vehicles 455, and/or IoT devices 495 can be the same as, or substantially similar to, computer 101, peripheral device set 114, end user device 103, devices 205, and/or server 235.

The VODMS 405 can be configured to issue blind spot actions to participating devices to attempt to prevent collisions between devices hidden within blind spots of moving vehicles (e.g., referred to as “hidden devices”) and moving vehicles. As discussed herein, a “hidden device” is a device that is associated with an object (e.g., a human, bicycle, carriage, animal, etc.) or that is an object (e.g., a vehicle or robot) that is hidden within a blind spot. As discussed herein, a “blind spot” refers to an area that is unable to be viewed within a FoV of a particular vehicle due to an obstacle (e.g., a visual obstruction). Thus, hidden devices are devices or objects associated therewith that are obstructed (partially or fully) by an obstacle with respect to a FoV of a vehicle. The VODMS 405 can issue blind spot actions if a given device is hidden within a blind spot of a first vehicle and/or has a projected movement path toward the first vehicle.

Vehicles 455 can comprise manual, semi-autonomous, or fully autonomous vehicles. Vehicles 455 can be a sedan, sport-utility-vehicle (SUV), truck, bus, all-terrain vehicle (ATV), aerial vehicle (e.g., plane, helicopter, quadcopter, etc.), train, ship (e.g., ferry, cruise liner, etc.), or a different form of vehicular transport. Implementation of vehicle obstacle detection management by VODMS 405 can depend on the type of vehicles 455 implemented. For example, vehicular obstacle detection management for marine and/or air vehicles can be performed similar to land vehicles. However, marine and/or air vehicles may consider 3-dimensional data.

Vehicles 455 can have autonomous capabilities. For example, vehicles 455 can include self-driving instructions which dictate various traffic rules that the vehicles 455 must follow while traveling. For example, self-driving instructions can include lane rules (e.g., specifying the correct side of the road, specifying that the car should remain in the center of a lane, etc.), light/signage rules (e.g., stop light rules, construction zone rules, school zone rules, yield, stop sign rules, etc.), acceleration/speed rules, situational rules (e.g., stopping during a school bus drop off, no right turns around a city bus), priority rules (e.g., yielding priority with multiple cars at an intersection), etc. In embodiments, the self-driving instructions depend on the applicable traffic rules in the jurisdiction where the vehicles 455 are operating. For example, traffic rules in the United States differ from traffic rules in the United Kingdom (e.g., right vs. left-handed traffic).

To follow the traffic rules set forth in the self-driving instructions, the vehicle 455-1 includes processing circuits 460-1 (e.g., collectively processing circuits 460 when referring to vehicles 455), memory 465-1 (e.g., collectively memories 465 when referring to vehicles 455), and/or autonomous components 470-1 (collectively autonomous components 470 when referring to vehicles 455). The autonomous components 470 can include sensors and control systems. The sensors can continuously collect sensor data while the vehicles 455 are operating, and the sensor data can be used to control the vehicles 455 (e.g., using proportional-integral-derivative (PID) control) by the one or more processing circuits 460 (e.g., as analyzed by a control system) of the vehicles 455. The sensors can include, but are not limited to, radar, computer vision, lidar, sonar, global positioning system (GPS), odometry, and inertial measurement units (IMUs). For example, computer vision may be used to recognize signage, brake lights, buses, traffic lines, etc., lidar can be used for object detection and avoidance, and GPS can be used for navigation routing. Generally, processing circuits 460 of vehicles 455 respond to the data collected by the sensors of autonomous components 470 to comply with the self-driving instructions. As discussed above, autonomous components 470 are not necessary for each vehicle 455. That is, guidance (e.g., and not self-driving instructions) can be provided on a display of a vehicle if autonomous capabilities are not present.

The display device 440 can include a processor (not shown), a memory (not shown), and a display (not shown) for displaying content. In embodiments, the display device 440 can be integrated within a vehicle 455-1. In embodiments, the display device 440 can be possessed by a user of vehicle 455-1. The display device 440 can display video content on a display and/or output audio content via a speaker. Any suitable display device can be implemented, including a heads-up display (HUD), integrated vehicular display (e.g., a navigation system), a mobile device, a tablet, a wearable, an XR device, or other display. The display device 440 can include any devices described with respect to FIG. 1-3. For example, display device 440 can include wearable devices, tablets, laptops, desktop computers, XR devices (e.g., augmented reality (AR) or virtual reality (VR) devices), gaming devices, and mobile devices (e.g., smart phones), among others.

In embodiments, the display device 440 is a heads-up display (HUD) of a vehicle 455-1. A heads-up display, also known as an HUD or Head-up Guidance System, is a transparent display that displays data without requiring users to look away from their usual viewpoints. Any suitable heads-up display technology can be utilized without departing from the spirit and scope of the present disclosure, including, but not limited to, reflective HUDs (e.g., where a windshield is treated such that an image can be projected onto the windshield and reflected to the user), combiner HUDs, and wind-shield integrated HUDs (e.g., where a transparent display is disposed between layers of a windshield). HUDs can be an LED-based HUD, an optical waveguide-based HUD, or a scanning laser HUD. HUDs can implement liquid crystal displays (LCDs), digital micro-mirrors (DMDs), and/or organic light-emitting diodes (OLEDs). This enables users of vehicles 455 to view displayed digital content in a relatively safe manner (e.g., without looking away from their usual driving viewpoints).

IoT devices 495 can include various sensors in vehicular environments that can collect sensor data that can be utilized for performing one or more functions within environment 400. For example, IoT devices 495, can include, among other potential sensors, traffic cameras, weather sensors, positioning sensors, optical sensors, and sensors of other vehicles (e.g., within a vehicle-to-vehicle (V2V) network). In embodiments IoT devices 495 can include positioning systems 497 such that positions of respective devices within environment 400 can be determined. Such positioning systems 497 can be global positioning systems (GPS) or local positioning systems (LPS). For example, positioning systems 497 can be beacon-based signaling systems, such as positioning systems based on signals of cellular base stations, Wi-Fi networks, LiFi access points, and radio broadcast towers. An example short-range wireless network that can be used for positioning is Bluetooth. Other short-range wireless networks that can be used for positioning include Wi-Fi, Bluetooth Low Energy (BLE), and Ultrawideband (UWB).

Various types of positioning systems 497 can be implemented. For example, in embodiments, IoT devices 495 can include an angle of arrival (AoA) antenna array. The AoA antenna array can be used for the purpose of locating other devices within environment 400 using AoA analysis. However, other types of positioning systems can be implemented such as grid concept positioning, time of arrival (ToA) positioning, joint angle and time of arrival positioning, received signal strength indication (RSSI) positioning, inertial measurement positioning, and location based on visual features (e.g., captured by a camera), among others.

Edge computing node 445 is a computing device that can be used for processing data relatively closer to a source for which data processing is required (e.g., a vehicular environment where obstacle detection management is implemented). Edge computing node 445 can be any suitable device within a vehicular environment that can be utilized for processing data to be used for performing functionalities within environment 400. Edge computing node 445 can be any device discussed with respect to FIG. 1-3 with the capability to process data. For example, edge computing node 445 can be configured to determine/obtain positioning data of devices, determine/obtain mobility characteristics of devices, determine/obtain obstacle data, perform blind spot detection, determine projected movement paths of devices, and/or issue blind spot actions.

The VODMS 405 includes a positioning data receiver 410, device position determiner 415, device mobility characteristic determiner 420, device mobility classifier 425, obstacle data receiver 427, blind spot detector 430, and blind spot action issuer 435. The functionalities of the positioning data receiver 410, device position determiner 415, device mobility characteristic determiner 420, device mobility classifier 425, obstacle data receiver 427, blind spot detector 430, and blind spot action issuer 435 can be processor-executable instructions that can be executed by a dedicated or shared processor using received inputs. In embodiments, functionalities completed by VODMS 405 do not necessarily have to be performed by the VODMS 405. For example, one or more functionalities discussed with respect to the positioning data receiver 410, device position determiner 415, device mobility characteristic determiner 420, device mobility classifier 425, obstacle data receiver, blind spot detector 430, and blind spot action issuer 435 can be performed by other components within environment 400, such as edge computing node 445, vehicles 455, and/or IoT devices 495.

The positioning data receiver 410 can be configured to receive positioning data from devices within environment 400. In embodiments, VODMS 405 can obtain device positioning data 485 from datastore 480. Device positioning data 485 can be obtained from a variety of sources, including positioning systems 497 of IoT devices 495, positioning systems of vehicles 455, and/or based on data collected from edge computing node 445. For example, device positioning data 485 can be obtained as collected by a GPS or LPS. Positioning data receiver 410 can obtain device positioning data 485 on a push or pull basis. In embodiments, device positioning data can be used to determine device mobility data 490. Functionalities of positioning data receiver 410 can be completed by various components (e.g., edge computing node 445, display device 440, IoT devices 495, vehicles 455, VODMS 405) within environment 400.

The device position determiner 415 can be configured to determine particular positions of particular devices at particular times. For example, based on the device positioning data 485, specific locations of specific devices can be determined using any suitable positioning protocol, such as the GPS or LPS protocols discussed above. For example, in implementations including an AoA antenna array, positions of respective devices can be determined using AoA analysis. The AoA analysis can be performed by device position determiner 415 or positioning system 497 of IoT devices. As such, the positions of various devices in a vehicular environment can be determined by the device position determiner 415. Such devices include devices of pedestrians, devices of cyclists, vehicles, devices associated with carriages, traffic devices (e.g., traffic lights), and the like. The positions of devices can be used for determining whether particular devices are within blind spots of moving vehicles. For example, following the example of FIG. 3, the position of the device of the pedestrian 320 can be compared to the position of the first vehicle 305 and the second vehicle 315 to determine whether the pedestrian 320 is within the blind spot of the first vehicle 305. Functionalities of device position determiner 415 can be completed by various components (e.g., edge computing node 445, display device 440, IoT devices 495, vehicles 455, VODMS 405) within environment 400.

The device mobility characteristic determiner 420 can be configured to determine mobility characteristics associated with specific devices within environment 400. The device mobility characteristic determiner 420 can leverage device positioning data 485 to calculate mobility characteristics such as speed, velocity, acceleration, and/or deceleration of specific devices and movement patterns/paths of specific devices. For example, the device mobility characteristic determiner 420 can determine the speed/acceleration of various devices based on distance traveled over discrete time intervals and/or changes of velocity over time. Additionally or alternatively, device mobility characteristic determiner 420 can obtain device mobility data 490 from datastore 480. Device mobility data 490 may include data such as the speed/velocity/acceleration of devices at particular times, the speed/velocity/acceleration of devices at particular locations, and/or the movement patterns of particular devices at particular times/locations.

In embodiments, mobility characteristics can be computed based on a statistical measure (e.g., an average, median, range, standard deviation value, etc.) over time. For example, mobility characteristics of a device can include an average speed of the device over a given timeframe. As an example, a first device may have an average speed of 5 mph (e.g., over the last hour) while a second device may have an average speed of 30 mph (e.g., over the last hour). The average speed of devices can be used for the classification of devices (e.g., whether the device is associated with a pedestrian, bicyclist, or car) as well as projected movement paths of devices.

Functionalities of device mobility characteristic determiner 420 can be completed by various components (e.g., edge computing node 445, display device 440, IoT devices 495, vehicles 455, VODMS 405) within environment 400.

The device mobility classifier 425 can be configured to classify respective devices into respective classifications based on the mobility characteristics associated with the respective devices. For example, classifications can be defined based on average speed ranges that devices fall into within a particular time frame. Classifications can be defined based on the average speed of a given device over the last 10 minutes, 30 minutes, hour, etc. Classifications of devices can be updated dynamically based on the most recent average speed of the device over a particular timeframe. As an example, devices with an average speed between 2-5 mph can be considered “walking pedestrians,” devices with an average speed between 5-10 mph can be considered “running pedestrians,” devices with an average speed between 10-20 mph can be considered “cyclists,” and devices with an average speed between 20-50 mph can be considered “vehicles.” However, any suitable number and type of mobility classifications can be assigned to specific devices based on any suitable mobility characteristic. Functionalities of device mobility classifier 425 can be completed by various components (e.g., edge computing node 445, display device 440, IoT devices 495, vehicles 455, VODMS 405) within environment 400.

The obstacle data receiver 427 can be configured to obtain and/or determine obstacle data 492 of obstacles within a vehicular environment. In embodiments, obstacle data 492 can be obtained from or transmitted to datastore 480. The obstacle data 492 can indicate the position of obstacles, mobility characteristics of obstacles (e.g., the speed and direction of obstacles, movement patterns of obstacles, etc.), and physical characteristics of obstacles (e.g., the physical dimensions and light characteristics of obstacles). As referenced herein “an obstacle” refers to a particular object that is obstructing (e.g., partially or fully) a field of view (e.g., a visual obstruction) of a vehicle within the vehicular environment. Thus, obstacles can include a variety of objects such as vehicles, buildings, landscaping features (e.g., boulders), signage, and structures (e.g., bus stops), to name a few. Obstacles can be moving or non-moving objects. Obstacles can be devices or can be associated with devices.

In embodiments where an obstacle is a device (e.g., a vehicle) or is otherwise associated with a device (e.g., pedestrians on a carriage or pedal tavern, bicyclists, etc.), positioning data and mobility characteristics of the device(s) associated with the obstacle can be used to determine portions of obstacle data 492 associated therewith. For example, if the obstacle is a vehicle, positioning data and mobility characteristics of the vehicle can be used to determine obstacle data 492 associated with the vehicle. In embodiments where the obstacle is not associated with a device, sensors within a sensor network (e.g., such as IoT devices 495, edge computing node 445, and/or vehicles 455), such as vehicular sensors, traffic device sensors, or other types of sensors can be configured to collect/determine obstacle data 492. For example, a computer vision sensor associated with vehicle 455-1, such as a camera or light detection and ranging (LIDAR) sensor, can be used to determine obstacle data of a first obstacle (e.g., a position, velocity, physical dimensions, and/or light characteristics of the first obstacle).

In embodiments, a combination of device positioning data 485, device mobility data 490, and/or environmental sensor data can be used to determine obstacle data 492. For example, if the obstacle is a bus, the position and mobility characteristics of the bus can be determined using device positioning data 485 and device mobility data 490 associated with the bus while the physical characteristics of the bus can be determined using computer vision sensors (e.g., autonomous components 470) of one or more vehicles 455 within environment 400. However, it is noted that any suitable type of data source, number of data sources, and/or type of data can be used to determine features of obstacles (e.g., obstacle data 492) within environment 400 without departing from the spirit and scope of the present disclosure.

In embodiments, each obstacle within obstacle data 492 can include an associated obstacle risk score. Obstacle risk scores can be assigned to obstacles based on their position, mobility characteristics, and physical characteristics. For example, an obstacle (e.g., a truck) that is relatively large, located near traffic, opaque, and frequently moves, can be assigned a relatively large obstacle risk score (e.g., 0.90 on a scale from 0.0-1.0, with values closer to 1.0 being a higher risk and values closer to 0.0 being a lower risk). Conversely, an obstacle (e.g., a bus stop) that is relatively small, positioned away from traffic, transparent, and stationary can be assigned a relatively low risk score (e.g., 0.05). Obstacle risk scores can be calculated based on a summation of weighted factors. For example, obstacle risk scores can be calculated according to:
Obstacle Risk Score=(size factor×size weight)+(position factor×position weight)+(light characteristic factor×light characteristic weight)+(mobility factor×mobility weight)

The factor values can correspond to each obstacle characteristic within obstacle data 492 that impacts the obstacle risk score. For example, a larger sized obstacle may have a greater magnitude size factor, an obstacle positioned near a vehicular environment may have a greater position factor, an obstacle that is opaque may have a greater light characteristic factor, and an obstacle that moves frequently may have a greater mobility factor. However, any suitable mapping between factor magnitudes and their impact on the obstacle risk score can be implemented. For example, in some embodiments, stationary obstacles may have a greater mobility factor than moving obstacles (e.g., stationary obstacles do move and thus may hide objects better). The weight of respective factors affects each respective factor's impact (e.g., significance) on the overall risk of an obstacle. For example, obstacle size and obstacle light characteristics may be assigned a relatively larger weight than obstacle position and obstacle mobility, or vice versa, depending on factors that are determined to be most impactful on obstacle risk.

Obstacle risk scores can be used for determining whether a given device is within a blind spot of a vehicle and/or to issue blind spot actions by VODMS 405. For example, if an obstacle risk score does not satisfy a threshold, a determination can be made that a given device is not within a blind spot of a vehicle (e.g., the obstacle is transparent and thus the driver/vehicle can view the device). Conversely, if an obstacle risk score does satisfy a threshold, a determination can be made that a given device is within a blind spot of a vehicle (e.g., the obstacle is large and opaque and thus the driver/vehicle cannot see the device). Similarly, the decision to issue blind spot actions, and the type of blind spot actions to issue, can depend on the magnitude of obstacle risk scores and/or comparisons between obstacle risk scores and one or more thresholds.

Functionalities of obstacle data receiver 427 can be completed by various components (e.g., edge computing node 445, display device 440, IoT devices 495, vehicles 455, VODMS 405) within environment 400.

In embodiments, the VODMS 405 can also consider a risk score of the hidden device. The risk score of the hidden device can consider factors such as a classification of the device (e.g., a bicycle, pedestrian, vehicle, etc.), historical mobility characteristics of the hidden device, the position of the hidden device, and factors associated with a user of the hidden device, such as an age of a user of the hidden device (e.g., a child, elder, or adult) or a disability status of the user (e.g., the user is within a wheel chair). The risk score of hidden devices can be compared to a threshold, in addition to, or alternative to, the obstacle risk score to determine whether to issue blind spot actions and the type of blind spot actions to issue. Determining whether to issue blind spot actions and the type of blind spot actions can depend on the magnitude of hidden device risk scores and/or comparisons between hidden device risk scores and one or more thresholds.

The blind spot detector 430 can be configured to determine whether a device is hidden within a blind spot of a FoV of a vehicle. The blind spot detector 430 can analyze the device positioning data 485, device mobility data 490, and/or obstacle data 492 with respect to a FoV of a vehicle to determine whether any devices are obstructed with respect to the FoV of the vehicle. For example, as depicted in FIG. 3, the position of the pedestrian 320 device is hidden behind the second vehicle 315 with respect to the FoV 310 of the first vehicle 305. Thus, due to the position of the pedestrian 320 being behind the second vehicle 315 and thus not detectable (e.g., viewable) within the FoV 310 of the first vehicle 305, a determination is made that the pedestrian 320 is within the blind spot of the FoV 310 of the first vehicle 305.

In embodiments, the blind spot detector 430 considers characteristics of the obstacle with respect to characteristics of the potentially hidden device or object associated with the device for the purpose of determining whether the potentially hidden device is within a blind spot of an FoV of a vehicle. For example, if the obstacle is larger than the potentially hidden device, the obstacle is opaque, and the obstacle is positioned in front of the potentially hidden device with respect to the FoV of the vehicle, a determination can be made that the potentially hidden device is indeed hidden within a blind spot. As another example, even if the obstacle is larger than the potentially hidden device, but the obstacle is transparent (e.g., a glass structure, such as a bus stop), a determination can be made that the potentially hidden device is not within a blind spot, as the user and/or vehicle can view the device through the transparent obstacle.

In embodiments, blind spot detector 430 can determine whether a potentially hidden device is within a blind spot based on an obstacle risk score of the obstacle. For example, if an obstacle risk score threshold is set to 0.50, such that any obstacle risk scores lower than 0.50 are not considered to cause a blind spot, and the obstacle risk score for the obstacle that is obstructing the potentially hidden device is 0.60, then a determination can be made that the potentially hidden device is within a blind spot based on the obstacle risk score exceeding (e.g., satisfying) the obstacle risk score threshold. Any suitable obstacle risk score threshold can be implemented for the purpose of determining whether a device is within a blind spot of an FoV of a vehicle.

In embodiments, the blind spot detector 430 can be configured to estimate, calculate, receive, or otherwise obtain a current FoV of a vehicle for the purposes of determining whether devices are hidden within blind spots with respect to the current FoV of the vehicle. For example, in embodiments where the vehicle has computer vision (e.g., camera views), the FoV of the vehicle can be determined based on the visual data collected by the vehicle. This can be used in autonomous vehicle use cases, which enables the VODMS 405 to determine devices that the autonomous vehicle can currently sense. As another example, the FoV of a user of the vehicle can be obtained via an eye-tracking device, head-mounted display, smart glasses, or smart contacts. As such, devices which have capabilities to detect directions the user is looking and the range that a user can safely view while driving can be considered to determine the FoV. In embodiments, the FoV of a user can be a pre-defined range encompassing an area in a direction which the vehicle is traveling. For example, if the vehicle is in reverse, the FoV can be adjusted based on the vehicle being in reverse, to detect obstacles that may be hiding objects while the vehicle is reversing. As another example, the FoV can be determined based on a manual indication by a user or based on a default setting of the VODMS 405. However, the FoV of the vehicle (e.g., or user thereof) can be determined in any suitable manner without departing from the spirit and scope of the present disclosure.

Thus, the blind spot detector 430 can consider the obstacle data 492, device positioning data 485, characteristics of potentially hidden devices, and an FoV of the vehicle to determine whether a given device is within a blind spot with respect to the FoV of the vehicle. Functionalities of blind spot detector 430 can be completed by various components (e.g., edge computing node 445, display device 440, IoT devices 495, vehicles 455, VODMS 405) within environment 400.

The blind spot action issuer 435 can be configured to issue blind spot actions to attempt to prevent collision between a device and a moving vehicle. A “blind spot action” refers to a command that notifies, warns, or causes control actions (e.g., braking, steering, etc.) to attempt to prevent a collision between a device within a blind spot of a vehicle and the vehicle. A variety of blind spot actions can be issued. Blind spot actions include causing display of visual data within vehicles indicating positions and projected paths of hidden devices approaching moving vehicles, issuing warnings to hidden devices warning hidden devices of oncoming moving vehicles, and/or causing autonomous or semi-autonomous vehicles to automatically perform control actions to prevent collisions with hidden devices, among others.

The blind spot action issuer 435 can be configured to issue blind spot actions in response to specific conditions. For example, the blind spot action issuer 435 may be configured to issue blind spot actions responsive to a determination made by the blind spot detector 430 that a device is within a blind spot of a FoV of a moving vehicle. Further, the blind spot action issuer 435 can be configured to issue blind spot actions responsive to determining that a projected movement path of the device within the blind spot is in a direction toward the moving vehicle. However, blind spot actions can be issued based on any suitable conditions. For example, in some embodiments, blind spot actions are issued when an obstacle risk score of an obstacle that is potentially obstructing a device exceeds an obstacle risk threshold.

In embodiments, the blind spot action issuer 435 can be configured to issue a blind spot action that causes display of visual data within vehicles indicating positions and projected movement paths of hidden devices approaching moving vehicles. For example, in response to determining that a blind spot action should be issued (e.g., a device is within a blind spot of an FoV of a vehicle and has a movement path toward the vehicle), the VODMS 405 may cause display of visual data within the moving vehicle which indicates a position of the hidden device that is obstructed as well as a movement path of the hidden device. An example of such a blind spot action is depicted in FIG. 9. In embodiments, the visual data can include an avatar depicting the mobility classification of the device. For example, if the hidden device is a pedestrian, an avatar depicting the hidden pedestrian can be virtually displayed within the visual warning. Similarly, if the hidden device is a cyclist, an avatar depicting the hidden cyclist can be virtually displayed within the visual warning. However, any suitable manner for visually displaying the position of the hidden device and the movement path of the hidden device can be implemented. In embodiments, the visual data is displayed on an HUD of the driving vehicle, such that the driver can view the visual data without limiting their ability to safely drive.

In embodiments, the blind spot action can include issuing warnings to hidden devices warning hidden devices of oncoming moving vehicles. For example, visual data can be displayed showing the position and movement path of the oncoming vehicle on the hidden device. In some embodiments, the blind spot action can include activating an alarm (or other audio output), providing haptic feedback, or providing textual/graphic warnings on the hidden device.

In some embodiments, the blind spot action can include causing IoT devices 495, edge computing node 445, and/or vehicles 455 within the vehicular environment to issue a specific command. For example, the blind spot action can include causing a nearby vehicle (e.g., the obstacle, if the obstacle is a vehicle) to sound an alarm, such as a car alarm or horn. As another example, the blind spot action can include causing a traffic control device (e.g., a digital pedestrian crosswalk device) to play a sound warning the hidden device (e.g., “Warning, Oncoming Vehicle!”). As another example, the blind spot action can include issuing a warning to another device in the vicinity (e.g., a user device that is not hidden, but is proximate to the hidden device). However, blind spot actions can be issued to any suitable device to attempt to prevent collision between the hidden device and the oncoming vehicle. Further, blind spot actions can include any suitable type of warning/notification (e.g., visual, haptic, or audio data).

In embodiments, the blind spot action can include causing autonomous or semi-autonomous vehicles to automatically perform control actions to prevent collisions with hidden devices. For example, the blind spot action issuer 435 can be configured to cause an autonomous or semi-autonomous vehicle to perform a specific driving control action, such as braking, steering, removing throttle, etc. The specific type of driving control action can depend on the speed of the moving vehicle, the movement path/speed of the hidden device, and the position of the vehicle with respect to the hidden device.

Thus, the VODMS 405 can be configured to detect pedestrians (e.g., associated with devices), bicyclists (e.g., associated with devices), vehicles, or moving devices (e.g., robotic devices) hidden within blind spots of particular vehicles. The VODMA 260 can further be configured to determine projected movement paths of devices hidden within blind spots of particular vehicles. Based on the above conditions, the VODMS 405 can be configured to issue one or more blind spot actions to attempt to prevent collisions between hidden devices and moving vehicles.

It is noted that FIG. 4 is intended to depict the representative major components of an example computing environment 400. In some embodiments, however, individual components can have greater or lesser complexity than as represented in FIG. 4, components other than or in addition to those shown in FIG. 4 can be present, and the number, type, and configuration of such components can vary.

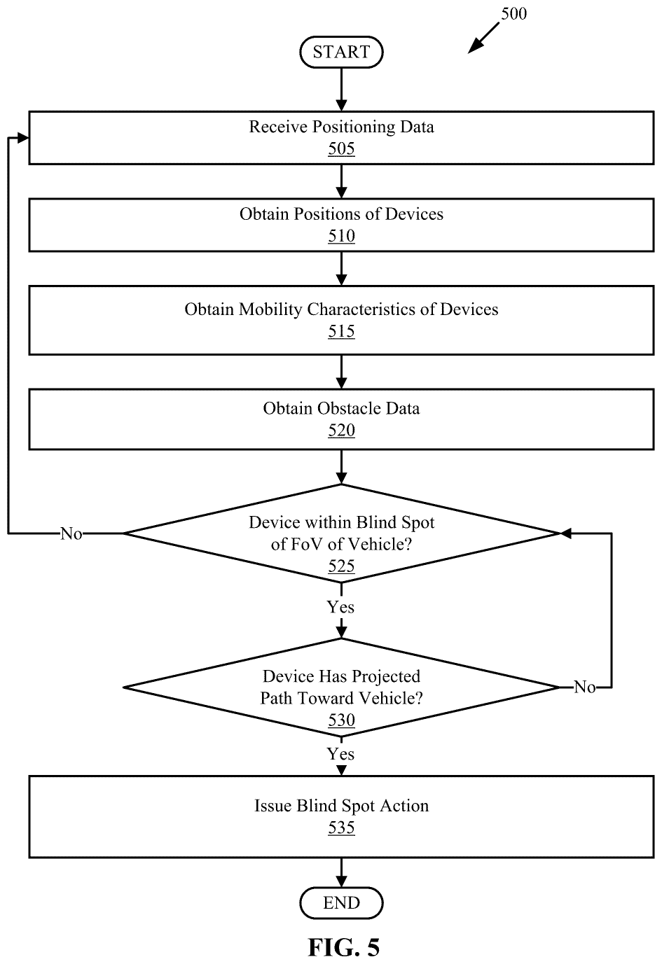

Referring now to FIG. 5, shown is a flow-diagram of an example method 500 for vehicle obstacle detection management, in accordance with embodiments of the present disclosure. One or more operations of method 500 can be completed by one or more processing circuits (e.g., computer 101, devices 205, server 235, vehicles 455, IoT devices 495, VODMS 405, display device 440, edge computing node 445).

Method 500 initiates at operation 505, where positioning data is received. The positioning data can be the same as, or substantially similar to, device positioning data 485 discussed with respect to FIG. 4. Device positioning data can be obtained using any suitable positioning system (e.g., a GPS or LPS) and using any suitable positioning technique (e.g., AoA versus ToA). Positions of devices are then obtained based on the positioning data. This is illustrated at operation 510. The position of each device within the vehicular environment may be obtained by one or more computing devices (e.g., VODMS 405, edge computing node 445, vehicles 455, etc.). For example, device positioning data can indicate positions of hidden devices, vehicles, and/or obstacles within vehicular environment.

Mobility characteristics are obtained. This is illustrated at operation 515. Mobility characteristics can be obtained in the same, or a substantially similar manner, as described with respect to the device mobility characteristic determiner 420 of FIG. 4. The mobility characteristics may be the same, or substantially similar to, device mobility data 490 of FIG. 4. The mobility characteristics can indicate the movement patterns and speed of devices within the vehicular environment. For example, mobility characteristics can indicate movement patterns and speed of hidden devices, vehicles, and/or obstacles within vehicular environment. The mobility characteristics of each device can be expressed as an average speed over a particular time frame. In embodiments, mobility characteristics can be used to classify devices into classifications in the same, or a substantially similar manner, as described with respect to the device mobility classifier 425 of FIG. 4.

Obstacle data is obtained. This is illustrated at operation 520. Obstacle data can be obtained in the same, or a substantially similar manner, as described with respect to the obstacle data receiver 427 of FIG. 4. The obstacle data can be the same, or substantially similar to, obstacle data 492 of FIG. 4. For example, obstacle data can indicate the position of respective obstacles, mobility characteristics of respective obstacles, and physical characteristics (e.g., physical dimensions and light characteristics) of respective obstacles.

A determination is made whether a device is within a blind spot of a FoV of a vehicle. This is illustrated at operation 525. Determining whether a device is within a blind spot of a FoV of a vehicle can be completed in the same, or a substantially similar manner, as discussed with respect to the blind spot detector 430 of FIG. 4. For example, characteristics of the obstacle within obstacle data 492, the position of the device, and the characteristics of the device (or object associated therewith) can be analyzed with respect to the FoV of the vehicle to determine whether the device is within the blind spot of the FoV of the vehicle. If a determination is made that the device is not within the blind spot of the FoV of the vehicle, then method 500 can return to operation 505 (e.g., where positioning data, mobility data, and obstacle data can continue to be collected/monitored/analyzed).

If a determination is made that the device is within the blind spot of the FoV of the vehicle, then a determination is made whether the device has a projected movement path toward the vehicle. This is illustrated at operation 530. Determining whether the device has a projected movement path toward the vehicle can be completed based on mobility characteristics of the device. As such, historical movements of the device can be analyzed to estimate a projected movement path the device will travel. In embodiments, the determination at operation 530 includes comparing the projected movement path of the device with a projected movement path of the vehicle. If a determination is made that the device does not have a projected movement path toward the vehicle, then method 500 can return to operation 525, where the hidden device can continue to be monitored until the hidden device is not within a blind spot.

If a determination is made that the device has a projected path toward the vehicle, then a blind spot action is issued. This is illustrated at operation 535. Issuing a blind spot action can be completed in the same, or a substantially similar manner, as described with respect to the blind spot action issuer 435 of FIG. 4. Various blind spot actions can be issued, as discussed with respect to the blind spot action issuer 435.

The aforementioned operations can be completed in any order and are not limited to those described. Additionally, some, all, or none of the aforementioned operations can be completed, while still remaining within the spirit and scope of the present disclosure. For example, in some embodiments, operation 530 may not be completed, and a blind spot action can be issued based solely on the device being within the blind spot of the FoV of the vehicle.

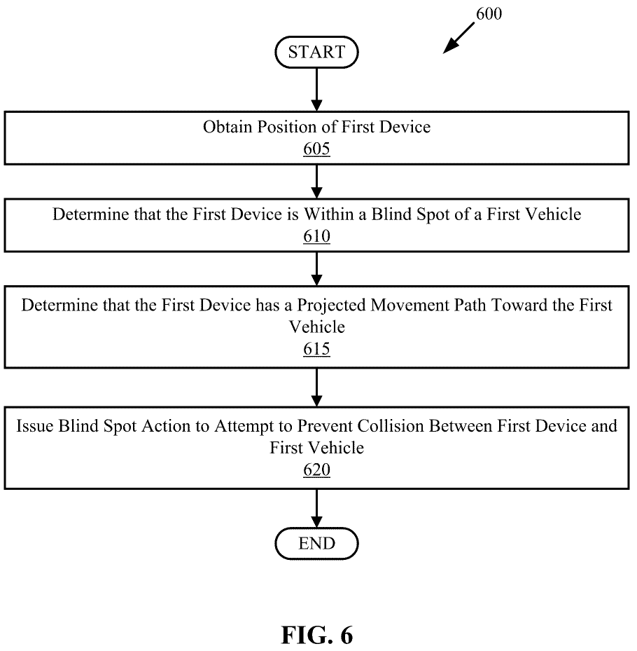

Referring now to FIG. 6, shown is a flow-diagram of another example method 600 for vehicle obstacle detection management, in accordance with embodiments of the present disclosure. One or more operations of method 600 can be completed by one or more processing circuits (e.g., computer 101, devices 205, server 235, vehicles 455, IoT devices 495, VODMS 405, display device 440, edge computing node 445).

Method 600 initiates at operation 605, where a position of a first device is obtained. The first device position can be obtained from device positioning data 485 discussed with respect to FIG. 4. Device positioning data 485 can be obtained using any suitable positioning system (e.g., a GPS or LPS) and using any suitable positioning technique (e.g., AoA versus ToA).

A determination is made that the first device is within a blind spot of a FoV of a first vehicle. This is illustrated at operation 610. Determining that the first device is within the blind spot of the FoV of the first vehicle can be completed in the same, or a substantially similar manner, as discussed with respect to the blind spot detector 430 of FIG. 4. For example, characteristics of an obstacle within obstacle data 492, the position of the first device, and the characteristics of the first device (or object associated therewith) can be analyzed with respect to the FoV of the first vehicle to determine that the first device is within the blind spot of the FoV of the first vehicle.

A determination is made that the first device has a projected movement path toward the first vehicle. This is illustrated at operation 615. Determining that the first device has a projected movement path toward the first vehicle can be completed based on mobility characteristics of the first device. As such, historical movements of the first device can be analyzed to estimate a projected movement path the first device will travel. In embodiments, this includes comparing the projected movement path of the first device with a projected movement path of the first vehicle.

A blind spot action is issued to attempt to prevent collision between the first device and first vehicle. This is illustrated at operation 620. Issuing a blind spot action can be completed in the same, or a substantially similar manner, as described with respect to the blind spot action issuer 435 of FIG. 4. Various blind spot actions can be issued, as discussed with respect to the blind spot action issuer 435.

The aforementioned operations can be completed in any order and are not limited to those described. Additionally, some, all, or none of the aforementioned operations can be completed, while still remaining within the spirit and scope of the present disclosure. For example, in some embodiments, operation 615 may not be completed, and a blind spot action can be issued based solely on the device being within the blind spot of the FoV of the vehicle.

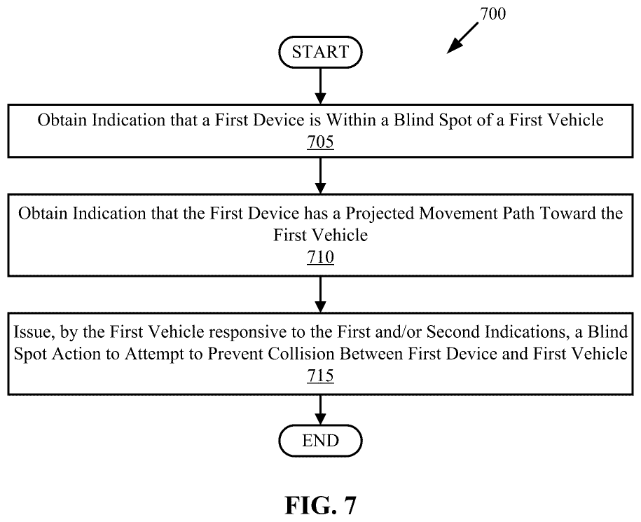

Referring now to FIG. 7, shown is a flow-diagram of another example method 700 for vehicle obstacle detection management, in accordance with embodiments of the present disclosure. One or more operations of method 700 can be completed by one or more processing circuits (e.g., computer 101, devices 205, server 235, vehicles 455, IoT devices 495, VODMS 405, display device 440, edge computing node 445).

Method 700 initiates at operation 705, where an indication that a first device is within a blind spot of a FoV of a first vehicle is obtained. Determining that the first device is within the blind spot of the FoV of the first vehicle can be completed in the same, or a substantially similar manner, as discussed with respect to the blind spot detector 430 of FIG. 4. For example, characteristics of an obstacle within obstacle data 492, the position of the first device, and the characteristics of the first device (or object associated therewith) can be analyzed with respect to the FoV of the first vehicle to determine that the first device is within the blind spot of the FoV of the first vehicle. The indication can be obtained from various processing circuits within a vehicular environment (e.g., computer 101, devices 205, server 235, vehicles 455, IoT devices 495, VODMS 405, display device 440, edge computing node 445).

An indication that the first device has a projected movement path toward the first vehicle is obtained. This is illustrated at operation 710. Determining that the first device has a projected movement path toward the first vehicle can be completed based on mobility characteristics of the first device. As such, historical movements of the first device can be analyzed to estimate a projected movement path the first device will travel. In embodiments, this includes comparing the projected movement path of the first device with a projected movement path of the first vehicle. The indication can be obtained from various processing circuits within a vehicular environment (e.g., computer 101, devices 205, server 235, vehicles 455, IoT devices 495, VODMS 405, display device 440, edge computing node 445).

A blind spot action is issued by the first vehicle to attempt to prevent collision between the first device and first vehicle responsive to the first and/or second indications. This is illustrated at operation 715. Issuing a blind spot action can be completed in the same, or a substantially similar manner, as described with respect to the blind spot action issuer 435 of FIG. 4. Various blind spot actions can be issued, as discussed with respect to the blind spot action issuer 435.

The aforementioned operations can be completed in any order and are not limited to those described. Additionally, some, all, or none of the aforementioned operations can be completed, while still remaining within the spirit and scope of the present disclosure. For example, in some embodiments, operation 710 may not be completed, and a blind spot action can be issued by the first vehicle based solely on the first indication obtained at operation 705.

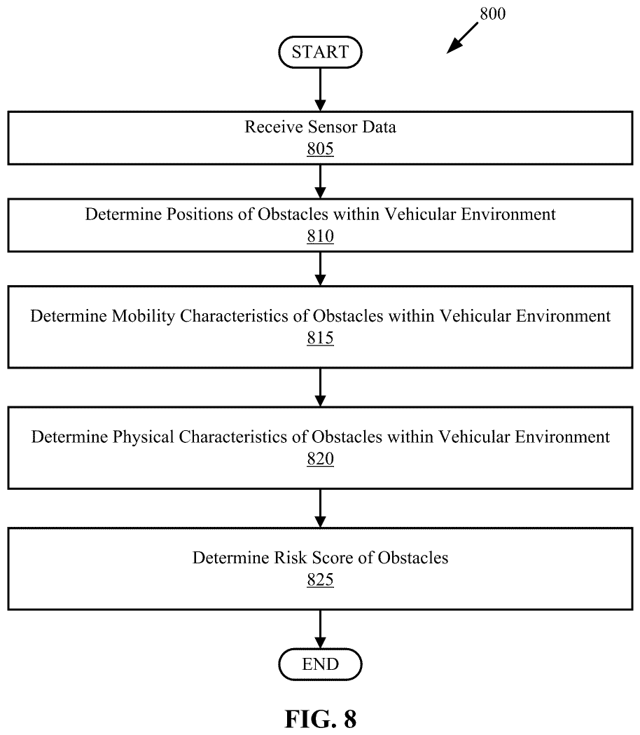

Referring now to FIG. 8, shown is a flow-diagram illustrating an example method for obtaining obstacle data associated with obstacles within a vehicular environment, in accordance with embodiments of the present disclosure. One or more operations of method 800 can be completed by one or more processing circuits (e.g., computer 101, devices 205, server 235, vehicles 455, IoT devices 495, VODMS 405, display device 440, edge computing node 445).

Method 800 initiates at operation 805, where sensor data is received. The sensor data can include device positioning data 485, device mobility data 490, and/or obstacle data 492. In embodiments, the sensor data includes sensor network data, such as IoT sensor data and V2V sensor data. Sensor network data can include sensor data received from autonomous components 470 of vehicles 455 of FIG. 4 and/or sensor data from various devices within the vehicular environment (e.g., traffic devices, edge computing nodes 445, IoT devices 495, cameras, optical sensors, etc.).

Positions of obstacles are determined within the vehicular environment. This is illustrated at operation 810. Determining the positions of obstacles can be completed using device positioning data 485 (e.g., if obstacles are or include devices), mobility data 490 (e.g., if obstacles are or include devices), and/or based on sensor network data (e.g., computer vision of vehicles 455, camera views of IoT devices 495, LIDAR data of vehicles 455, etc.).

Mobility characteristics of obstacles are determined within the vehicular environment. This is illustrated at operation 815. Determining the mobility characteristics of obstacles can be completed using device positioning data 485 (e.g., if obstacles are or include devices), mobility data 490 (e.g., if obstacles are or include devices), and/or based on sensor network data (e.g., computer vision of vehicles 455, camera views of IoT devices 495, LIDAR data of vehicles 455, etc.).

Physical characteristics of obstacles are determined within the vehicular environment. This is illustrated at operation 820. Physical characteristics of obstacles include physical dimensions of objects (e.g., the width, length, height, and shape of objects) and light characteristics of objects (e.g., the opaqueness and transparency of objects. Physical characteristics of objects can be determined using sensor network data (e.g., computer vision of vehicles 455, camera views of IoT devices 495, LIDAR data of vehicles 455, etc.).

Risk scores of obstacles can be determined. This is illustrated at operation 825. Determining the risk score of obstacles can be completed in the same, or a substantially similar manner, as described with respect to the obstacle data receiver 427 of FIG. 4. For example, a summation of weighted obstacle characteristic factors can be calculated to determine obstacle risk scores. The obstacle risk scores and/or obstacle data can then be transmitted/stored for analysis for the purpose of vehicle obstacle detection management.

The aforementioned operations can be completed in any order and are not limited to those described. Additionally, some, all, or none of the aforementioned operations can be completed, while still remaining within the spirit and scope of the present disclosure.

Referring now to FIG. 9, shown is exemplary visual data that can be displayed on a display device of a vehicle as a blind spot action, in accordance with embodiments of the present disclosure. The vehicle can display (e.g., as caused by one or more other devices, such as edge computing node 445 or VODMS 405) the visual data on any suitable display device. The display device can correspond to view 905 (e.g., an HUD of a windshield) or a portion of the view 905.

As shown in FIG. 9, a visual data display area 930 depicts virtual data to attempt to prevent collision between a device 910 (e.g., a pedestrian in possession of a device) and a vehicle (e.g., the vehicle to which the view 905 corresponds). The visual data display area 930 includes a warning signal 920 to draw attention to the potentially dangerous traffic situation. The visual data display area 930 further includes an obstacle 915, shown as a boulder. The visual data display area 930 further includes a projected movement path 925 of the device 910. Thus, the visual data display area 930 can warn a driver of the vehicle observing the view 905 of the potential for collision with the device 910. As such, the driver of the vehicle can take appropriate measures (e.g., braking, steering, sounding a horn, etc.) to attempt to prevent collision with the pedestrian of the device 910.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A computer-implemented method comprising:
obtaining a position of a first device;
determining that the first device is within a blind spot of a first vehicle, wherein the blind spot indicates that the first device is hidden by an obstacle within a field of view (FoV) of the first vehicle;
determining that the first device has a projected movement path toward the first vehicle;
issuing, in response to determining that the first device is within the blind spot of the first vehicle and that the first device has the projected movement path toward the first vehicle, a blind spot action to attempt to prevent a collision between the first device and the first vehicle.

2. The computer-implemented method of claim 1, wherein determining that the first device is within the blind spot of the first vehicle includes:
obtaining a position of the obstacle;
obtaining physical characteristics of the obstacle; and
determining that the first device is hidden by the obstacle within the FoV of the first vehicle based on the position of the first device with respect to the position of the obstacle and the physical characteristics of the obstacle.

3. The computer-implemented method of claim 1, wherein issuing the blind spot action comprises:
causing display of the projected movement path of the first device on a display device within the first vehicle.

4. The computer-implemented method of claim 3, wherein the display device within the first vehicle is a head-up display (HUD).

5. The computer-implemented method of claim 1, wherein the first vehicle includes autonomous capabilities, wherein issuing the blind spot action comprises:
causing the first vehicle to perform an autonomous vehicle action to prevent the first vehicle from colliding with the first device.

6. The computer-implemented method of claim 1, wherein issuing the blind spot action comprises:
issuing a warning to the first device notifying the first device of the first vehicle.

7. The computer-implemented method of claim 1, wherein determining that the first device has the projected movement path toward the first vehicle is determined based on historical positioning data associated with the first device.

8. A system comprising:
one or more processors; and
one or more computer-readable storage media collectively storing program instructions which, when executed by the one or more processors, are configured to cause the one or more processors to perform a method comprising:
obtaining a first indication that a first device is within a blind spot of a first vehicle, wherein the blind spot indicates that the first device is hidden by an obstacle within a field of view (FoV) of the first vehicle;
obtaining a second indication that the first device has a projected movement path toward the first vehicle; and
issuing, by the first vehicle responsive to the first and second indications, a blind spot action to attempt to prevent collision between the first device and the first vehicle.

9. The system of claim 8, wherein issuing, by the first vehicle, the blind spot action comprises:
displaying the projected movement path of the first device on a display device within the first vehicle.

10. The system of claim 9, wherein an object associated with the first device is displayed with the projected movement path within the blind spot action.

11. The system of claim 9, wherein the display device within the first vehicle is a head-up display (HUD).

12. The system of claim 8, wherein the first vehicle includes autonomous capabilities, wherein issuing, by the first vehicle, the blind spot action comprises:
performing an autonomous vehicle action to prevent the first vehicle from colliding with the first device.

13. The system of claim 8, wherein issuing, by the first vehicle, the blind spot action comprises:
issuing a warning to the first device notifying the first device of the first vehicle.

14. The system of claim 8, wherein the first and second indications are obtained from an edge computing device within a vehicular environment of the first vehicle.

15. A computer program product comprising one or more computer readable storage media, and program instructions collectively stored on the one or more computer readable storage media, the program instructions comprising instructions configured to cause one or more processors to perform a method comprising:
obtaining a position of a first device;
determining that the first device is within a blind spot of a first vehicle, wherein the blind spot indicates that the first device is hidden by an obstacle within a field of view (FoV) of the first vehicle;
determining that the first device has a projected movement path toward the first vehicle;
issuing, in response to determining that the first device is within the blind spot of the first vehicle and that the first device has the projected movement path toward the first vehicle, a blind spot action to attempt to prevent a collision between the first device and the first vehicle.

16. The computer program product of claim 15, wherein determining that the first device is within the blind spot of the first vehicle includes:
obtaining a position of the obstacle;
obtaining physical characteristics of the obstacle; and
determining that the first device is hidden by the obstacle within the FoV of the first vehicle based on the position of the first device with respect to the position of the obstacle and the physical characteristics of the obstacle.

17. The computer program product of claim 15, wherein issuing the blind spot action comprises:
causing display of the projected movement path of the first device on a display device within the first vehicle.

18. The computer program product of claim 17, wherein the display device within the first vehicle is a head-up display (HUD).

19. The computer program product of claim 15, wherein the first vehicle includes autonomous capabilities, wherein issuing the blind spot action comprises:
causing the first vehicle to perform an autonomous vehicle action to prevent the first vehicle from colliding with the first device.

20. The computer program product of claim 15, wherein issuing the blind spot action comprises:
issuing a warning to the first device notifying the first device of the first vehicle.
